(19) United States
(12) Patent Application Publication
(10) Pub. No.: US 2015/0092520 A1
(43) Pub. Date: Apr. 2, 2015

(54) Adaptive Trigger Point For Smartwatch Gesture-to-Wake

(71) Applicant: Google Inc., Mountain View, CA (US)

(72) Inventors: Austin Robison, Palo Alto, CA (US); Nicholas John Vaccaro, San Jose, CA (US)

(73) Assignee: Google Inc., Mountain View, CA (US)

(21) Appl. No.: 14/099,617

(22) Filed: Dec. 6, 2013

Related U.S. Application Data
(60) Provisional application No. 61/883,761, filed on Sep. 27, 2013.

(51) Int. Cl. G04G 21/00

(52) U.S. Cl. CPC G04G 21/00
USPC 368/9

(57) ABSTRACT

While in a first mode, a smartwatch can power down a majority of the smartwatch components to save power. In order to change modes, the watch may use a two-step method. The method for changing modes of the smartwatch includes detecting a movement of the smartwatch with a first sensor, such as an accelerometer, located in the smartwatch based on the movement indicating a command request. After the movement is detected, the smartwatch may power on a second sensor located in the smartwatch to detect a second event, such as an audio signal, with the second sensor. Finally, if the second sensor indicates a command request, then the method includes changing the mode the smartwatch. Based on either input provided to the smartwatch or a lack of input, the smartwatch can adapt a threshold at which the movement would trigger a command request.

### CROSS-REFERENCE TO RELATED APPLICATIONS

This application makes reference to and claims priority to U.S. Provisional Application Ser. No. 61/883,761, filed on Sep. 27, 2017, entitled “Adaptive Trigger Point For Smartwatch Gesture-to-Wake,” which is incorporated herein by reference in its entirety.

### BACKGROUND

Unless otherwise indicated herein, the materials described in this section are not prior art to the claims in this application and are not admitted to be prior art by inclusion in this section.

Wearable computing devices are becoming increasingly popular in various forms and for various purposes. One type of wearable computing device is a smartwatch. A smartwatch may be a device that is worn on the wrist or arm, like a traditional watch, but has more interactive features. The display of a smartwatch may be an LCD screen similar to that found in a smartphone. A smartwatch may also provide internet connectivity. Additionally, a smartwatch may be configured for more intelligent functions than just displaying the time, such as some or all the functionality that is typically provided by smartphones and/or portable digital music players. Further, there may be various ways the wearer could interact with a user interface on the display of the smartwatch. For example, a wearer may instruct the smartwatch to retrieve information from the internet to display to the wearer.

### SUMMARY

Unlike a traditional watch, a smartwatch features a variety of sensors, a screen, at least one input device, and other battery-powered features. Thus, a smartwatch generally may use more power than a traditional watch. Due to the increase in power usage as compared to a traditional watch, a smartwatch may have a shorter battery (or other power source) lifespan. Therefore, it may be desirable to reduce the power usage of the smartwatch. Disclosed herein are methods and apparatuses that may help to reduce the power consumption of a smartwatch.

One method disclosed may be performed by a computing device having one or more first sensors, one or more second sensors, and a battery configured to power the first and second sensors. The method includes entering a first operating mode in which the battery powers the one or more first sensors and the one or more second sensors are not powered by the battery. The method also includes switching from the first operating mode to a second operating mode in response to detecting (a) data from the one or more first sensors corresponding to a movement of the computing device that exceeds at least one movement threshold, followed by (b) audio data from the one or more second sensors that comprises a predetermined voice command, where one or more second sensors are powered on in response to detecting data from the one or more first sensors corresponding to the movement of the computing device that exceeds at least one movement threshold. The method also includes determining that the movement of the computing device exceeds the at least one movement threshold by more than a threshold amount and responsively increasing the at least one movement threshold.

Another disclosed method is performed by a computing device having one or more first sensors, one or more second sensors, and a battery configured to power the first and second sensors. The method includes entering a first operating mode in which the one or more first sensors are powered on and configured to detect the movement of the computing device and the one or more second sensors are powered off. The computing device may be configured to switch from the first operating mode to a second operating mode in response to detection of: (a) a movement of the computing device that exceeds the at least one movement threshold followed by (b) audio data from the one or more second sensors that comprises a predetermined voice command. While in the first operating mode, the method may include receiving an input-error signal that indicates the device failed to detect a movement of the computing device that was intended to exceed the at least one movement threshold. In response to the input-error signal, the method includes decreasing the at least one movement threshold.

Additionally, the present disclosure includes a device with a first sensor configured to detecting a first event, a second sensor configured to detect a second event; a processing unit, and a battery configured to provide power to the first sensor, the second sensor, and the processing unit. The processing unit may be configured to enter a first operating mode in which the one or more first sensors are powered by the battery and the one or more second sensors are not powered by the battery. The processing unit may also be configured to switch from the first operating mode to a second operating mode in response to detecting (a) data from the one or more first sensors corresponding to a movement of the computing device that exceeds at least one movement threshold, followed by (b) audio data from the one or more second sensors that comprises a predetermined voice command, where one or more second sensors are powered on in response to detecting data from the one or more first sensors corresponding to the movement of the computing device that exceeds at least one movement threshold. Additionally, the processing unit may determine that the movement of the computing device exceeds the at least one movement threshold by more than a threshold amount and responsively increasing the at least one movement threshold.

Another disclosed device includes a first sensor configured to detecting a first event, a second sensor configured to detect a second event, a processing unit, and a battery configured to provide power to the first sensor, the second sensor, and the processing unit. The processing unit may be configured to enter a first operating mode in which the one or more first sensors are powered on and configured to detect the movement of the computing device and the one or more second sensors are powered off. The computing device may be configured to switch from the first operating mode to a second operating mode in response to detection of (a) a movement of the computing device that exceeds the at least one movement threshold followed by (b) audio data from the one or more second sensors that comprises a predetermined voice command. The computing device may be further configured to, while in the first operating mode, receive an input-error signal that indicates the device failed to detect a movement of the computing device that was intended to exceed the at least one movement threshold. Additionally, the computer system may, in response to the input-error signal, decrease the at least one movement threshold.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the claims.

### BRIEF DESCRIPTION OF THE FIGURES

FIG. 1 illustrates an example smartwatch in communication with a mobile device.

FIG. 2 shows a simplified block diagram of an example computer network infrastructure.

FIG. 3 shows a simplified block diagram depicting example components of an example computing system.

FIG. 4A shows an example gesture with the smartwatch.

FIG. 4B shows an example gesture with the smartwatch.

FIG. 5 shows an example method for interacting with the smartwatch.

FIG. 6 shows an example computer readable medium for use with the smartwatch.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

The methods and systems disclosed herein generally relate to reducing the power usage a wearable computing device. One type of wearable computing device is a smartwatch. A smartwatch may be a device that is worn on the wrist or arm, like a traditional watch, but has more interactive features, such as in interactive display. A smartwatch may include wireless connectivity, such as internet connectivity. Further, there may be various ways the wearer could interact with the smartwatch. In one way, a wearer may interact with a user interface on the display of the smartwatch. For example, a wearer may instruct the smartwatch to retrieve information from the internet to display to the wearer.

In one example embodiment, the power used by the smartwatch may be reduced by the use of a sleep mode. While in the sleep mode, the watch can power down a majority of the sensors and/or the screen. By only having a minimal number of sensors and other electronics enabled, the smart watch may be able to significantly increase its battery life. It may also be desirable for the smartwatch to be able to quickly return to an operation mode when a wearer of the smartwatch desires.

In order to exit sleep mode, the watch may detect a movement of the smartwatch with a motion sensor located in the smartwatch. In some embodiments, the motion sensor may be either a gyroscope and/or accelerometer. The movement of the smartwatch may indicate a command request, such as the smartwatch being moved into the field of view of the wearer of the smartwatch. The smartwatch may compare a measured movement to a threshold. In some embodiments, only movements that are greater than the threshold may be interpreted as a command request.

After the movement of the smartwatch is detected to exceed the threshold, the smartwatch may power on a microphone located in the smartwatch to detect a sound. The command request may be the voice of the wearer of the smartwatch. The detected sound may be either a command or an authentication from a wearer of the smartwatch. Finally, if the microphone indicates a command request, then the method includes waking the smartwatch. In various embodiments, waking the watch may perform one or more of several operations. For example, the waking of the smartwatch may be based on the command received by the microphone. In this example, a command may instruct the smartwatch to take a picture. Thus, waking the smartwatch may include powering on a camera of the smartwatch. In other embodiments, waking the smartwatch may include waking other sensors or components of the smartwatch.

Embodiments also include the smartwatch adapting the detection of the movement gesture based on a received input. During operation of the smartwatch, the movement measured by the movement sensor may be compared to a threshold. When the movement sensor detects a movement that exceeds the threshold, the smartwatch will interpret the movement as a command request.

The movement threshold may be set in a variety of ways. In one embodiment, when a smartwatch is first worn, a calibration routine may be performed to create a threshold for the movement gesture. In another embodiment, the threshold may be pre-programmed in the smartwatch before it is ever purchased. In other embodiments, the initial threshold may be set in other ways as well.

As previously discussed, during subsequent operation of the smartwatch, the threshold may be adapted in various ways. In one example, an input may be provided to the smartwatch if the smartwatch prematurely wakes. The threshold may be increased in response to the input in order to make the threshold less likely to be surpassed. In a second example, a second input may be provided to the smartwatch if the smartwatch does not wake based on a gesture. The threshold may be decreased in response to the second input in order to make the threshold more likely to be surpassed. In additional examples, the smartwatch may adapt the threshold based on the lack of receiving a second input. For example, the smartwatch may detect the first threshold and wait a period of time waiting to detect a sound. If the sound is not detected within the period of time, the threshold may be increased.

Therefore, a reduced set of set of sensors may be enabled until the smartwatch detects a movement of the smartwatch, at which another sensor, like a microphone, is activated. If the microphone also detects a waking event, then the smartwatch may be fully powered.

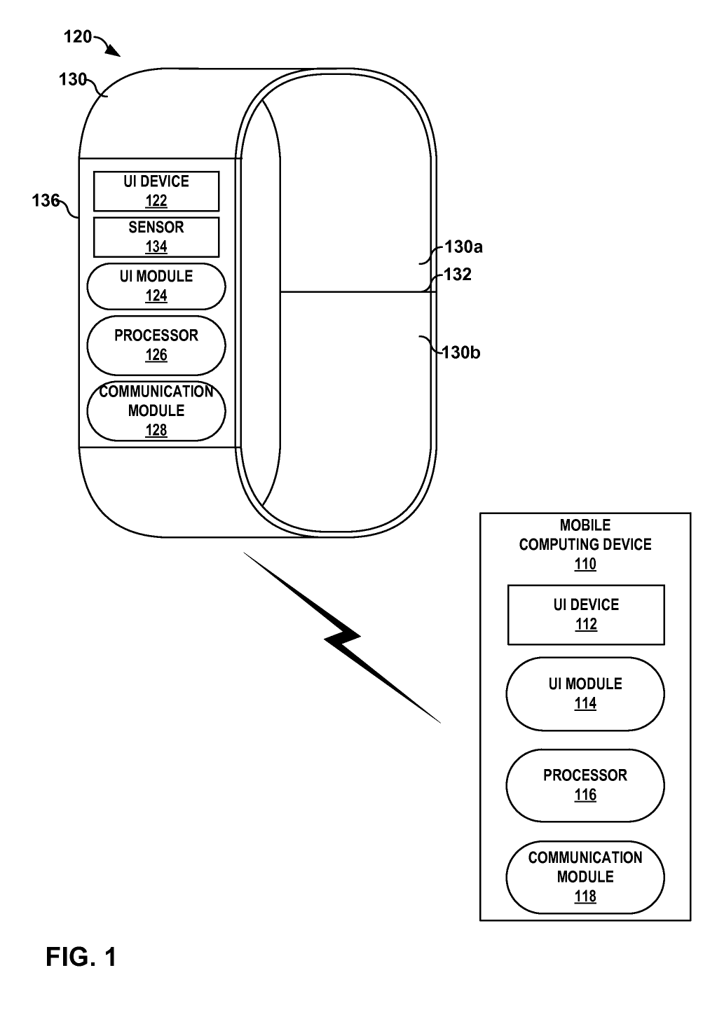

FIG. 1 illustrates an example smartwatch 120 in communication with a mobile device 110. The smartwatch 120 may be worn around a wearer's wrist with the aid of a watchstrap 130. The watchstrap 130 may have a top portion 130a and a bottom portion 130b, which meet at a clasp position 132. The smartwatch 130 also includes electronics unit 136.

In various embodiments, the electronics unit 136 contains various different components. FIG. 1 presents one possible arrangement of components for the electronics unit 136. In the embodiment shown in FIG. 1, the electronics unit 136 includes a user interface device 122, sensor unit 134, user interface module 124, processor 126, and a communication module 128. In some embodiments, the smartwatch may also include a speaker (not pictured).

The user interface device 122 may be coupled to the user interface module 124. The user interface device 122 may includes a liquid crystal display (LCD) screen and touch-sensitive components. The LCD screen may present visual elements to a wearer of the LCD. The touch-sensitive components of the user interface module 124 may interact with a wearer of the smartwatch to provide an input to the smartwatch. The user interface module 124 may include electronic components configured to operate the user interface device 122. The user interface module 124 may control the images shown on the LCD screen as well as interact with the touch-sensitive components of the user interface module 124.

In alternative embodiments, other types of display elements may also be used. For example, the user interface device 122 may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver (such as user interface module 124) may be disposed within the smartwatch 120 for driving such a matrix display. Alternatively or additionally, a laser or light emitting diode (LED) source and scanning system could be used to draw a raster display for one or more of the smartwatch wearer's eyes. Other possibilities for the display exist as well.

The touch-sensitive components may sense at least one of a position and a movement of a finger via capacitive sensing, resistance sensing, or a surface acoustic wave process, among other possibilities. The touch-sensitive components may be capable of sensing finger movement in a direction parallel or planar to the pad surface, in a direction normal to the pad surface, or both, and may also be capable of sensing a level of pressure applied to the component surface. The touch-sensitive components may be formed of one or more translucent or transparent insulating layers and one or more translucent or transparent conducting layers. Edges of the touch-sensitive components may be formed to have a raised, indented, or roughened surface, so as to provide tactile feedback to a user when the user's finger reaches the edge, or other area, of the touch-sensitive components. If more than one touch-sensitive component is present, each touch-sensitive component may be operated independently, and may provide a different function.

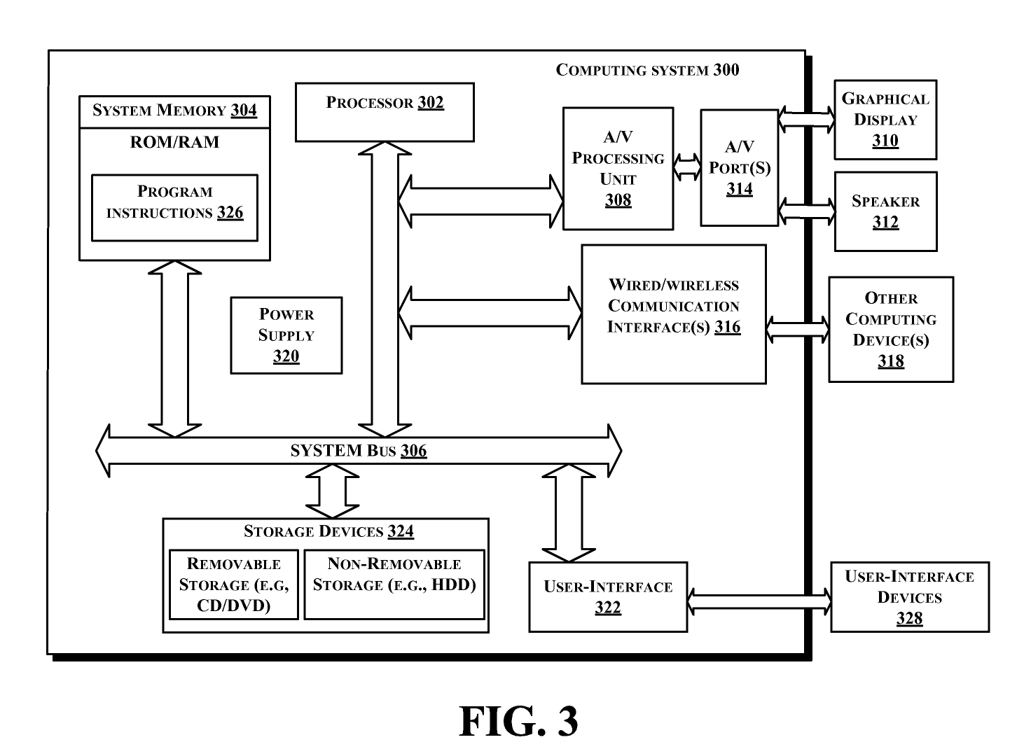

The smartwatch 120 may also include an on-board computing system powered by a processor 126. The processor may be a general-purpose processor, a custom made processor, or other processor configured to perform tasks within the present disclosure. The on-board computing system may be positioned in a unit of the smartwatch that includes the display; however, in other embodiments, the on-board computing system may be located on or within watchstrap 130 (or on another part of the smartwatch 120). The on-board computing system 118 may include a memory coupled to the processor 126, for example. The on-board computing system may be configured to receive and analyze data from various sensors in the smartwatch 120 or communicated to smartwatch 120. An example computing system is further described below in connection with FIG. 3.

The sensor unit 134 may includes a variety of different sensors. The sensors may include a gyroscope, an accelerometer, a light sensor, an air pressure sensor, a microphone, a speaker, a touch-sensitive sensor, for example. The sensor unit may also include various other sensors. Each sensor may be configured to sense and/or receive an input form a user of the smartwatch 120.

The communication module 128 may allow the smartwatch 120 to communicate wirelessly. The smartwatch 120 may communicate with a mobile computing device 110, with wireless devices, with networked computers, for example. The communication module 128 is illustrated as a wireless connection; however, wired connections may also be used. For example, the communication module 128 may include a wired serial bus such as a universal serial bus or a parallel bus, among other connections. The communication module 128 may also include a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Either of such a wired and/or wireless connection may be a proprietary connection as well.

As shown in FIG. 1, the smartwatch 120 may be able to wirelessly communicate with a mobile computing device 110. The mobile computing device 110 may provide information, connectivity, processing power, or instructions to the smartwatch 120. In some embodiments, the smartwatch 120 may need to be coupled to a mobile computing device 110 to achieve full functionality. However, in other embodiments, the smartwatch 120 may have full functionality without being coupled to the mobile computing device 110.

For example, in one embodiment the smartwatch 120 may only have short-range wireless communication abilities. In this embodiment, the smartwatch 120 may use the short-range wireless communication to couple to the mobile computing device 110. Through this short-range wireless communication, the smartwatch 120 may achieve long-range wireless communication via the networking provided by the communication module 118 of the mobile computing device 110. The smartwatch 120 may receive an input from the mobile computing device 110. A wearer of smartwatch 120 may provide an input to a user interface 112 of mobile computing device 110. The input received by the user interface 112 of mobile computing device 110, will be relayed to smartwatch 120. And still further embodiments, the smartwatch 120 may send data to mobile computing device 110 for processing by processor 116 in the mobile computing device 110. For example, the smartwatch 120 may receive a command from a wearer of the smartwatch. The command may indicate a processor-intensive instruction. Rather than process the instruction by itself, the smartwatch 120 will send the instruction to mobile computing device 110 for processing by the processor 116. In one specific example, a wearer of the smartwatch 120 may indicate she would like to send an email. When she enters the email command to the smartwatch 120, it may be relayed to mobile computing device 110. The mobile computing device 110 may create a new email the wearer of the smartwatch 120 can access via the user interface 112 of mobile computing device 110. Therefore, in some embodiments, the smart watch 120 and the mobile computing device 110 may have a symbiotic relationship.

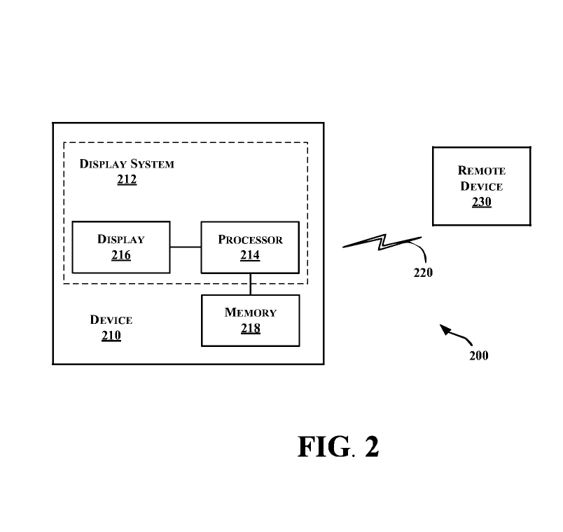

FIG. 2 shows a simplified block diagram of an example computer network infrastructure. In system 200, a device 210 communicates using a communication link 220 (e.g., a wired or wireless connection) to a remote device 230. The device 210 may be any type of device that can receive data and display information corresponding to or associated with the data. For example, the device 210 may be a wearable computing device, such as the smartwatch 120 described with reference to FIG. 1.

Thus, the device 210 may include a display system 212 comprising a processor 214 and a display 216. The display 216 may be, for example, an optical see-through display, an optical see-around display, or a video see-through display. The processor 214 may receive data from the remote device 230, and configure the data for display on the display 216. The processor 214 may be any type of processor, such as a microprocessor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

In FIG. 2, the communication link 220 is illustrated as a wireless connection; however, wired connections may also be used. For example, the communication link 220 may be a wired serial bus such as a universal serial bus or a parallel bus, among other connections. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Either of such a wired and/or wireless connection may be a proprietary connection as well. The remote device 230 may be accessible via the Internet and may include a computing cluster associated with a particular web service (e.g., social-networking, photo sharing, address book, etc.).

As described above in connection with FIGS. 1A-2B, an example wearable computing device may include, or may otherwise be communicatively coupled to, a computing system, such as computing system 118 or computing system 204. FIG. 3 shows a simplified block diagram depicting example components of an example computing system 300. One or both of the device 210 and the remote device 230 may take the form of computing system 300.

Computing system 300 may include at least one processor 302 and system memory 304. In an example embodiment, computing system 300 may include a system bus 306 that communicatively connects processor 302 and system memory 304, as well as other components of computing system 300. Depending on the desired configuration, processor 302 can be any type of processor including, but not limited to, a microprocessor (μP), a microcontroller (μC), a digital signal processor (DSP), or any combination thereof. Furthermore, system memory 304 can be of any type of memory now known or later developed including but not limited to volatile memory (such as RAM), non-volatile memory (such as ROM, flash memory, etc.) or any combination thereof.

An example computing system 300 may include various other components as well. For example, computing system 300 includes an A/V processing unit 308 for controlling graphical display 310 and speaker 312 (via A/V port 314), one or more communication interfaces 316 for connecting to other computing devices 318, and a power supply 320. Graphical display 310 may be arranged to provide a visual depiction of various input regions provided by user-interface module 322. For example, user-interface module 322 may be configured to provide a user-interface, and graphical display 310 may be configured to provide a visual depiction of the user-interface. User-interface module 322 may be further configured to receive data from and transmit data to (or be otherwise compatible with) one or more user-interface devices 328.

Furthermore, computing system 300 may also include one or more data storage devices 324, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by computing system 300.

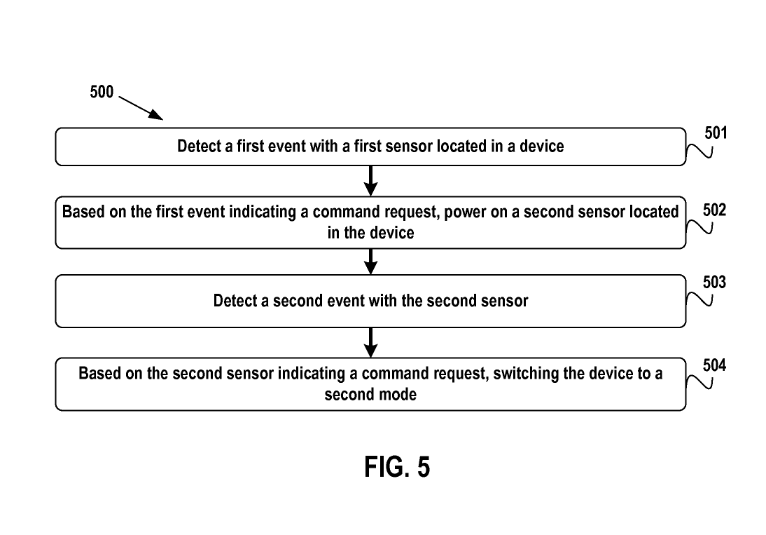

According to an example embodiment, computing system 300 may include program instructions 326 that are stored in system memory 304 (and/or possibly in another data-storage medium) and executable by processor 302 to facilitate the various functions described herein including, but not limited to, those functions described with respect to FIG. 5. Although various components of computing system 400 are shown as distributed components, it should be understood that any of such components may be physically integrated and/or distributed according to the desired configuration of the computing system.

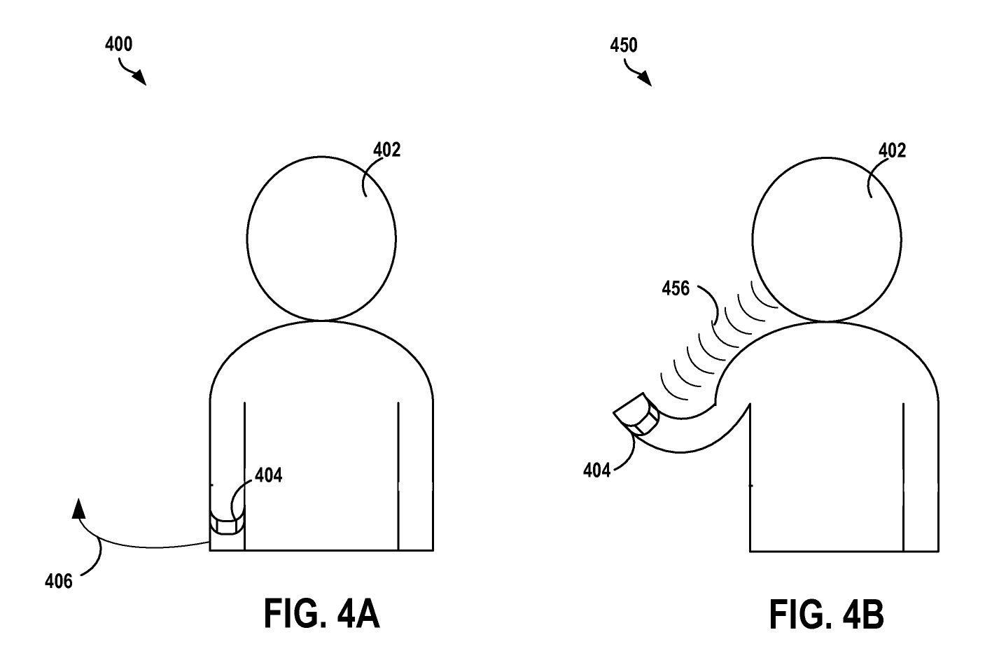

FIGS. 4A and 4B show aspects of example gestures 400 and 450 that may be detected by a smartwatch. The wearer of the smartwatch may perform the gestures 400 and 450 in order to wake the smartwatch from a low power (e.g., sleeping) state.

As shown in FIG. 4A, the wearer 400 of the smartwatch 404 may have the smartwatch 404 on his or her arm. When he or she wishes to view or interact with the smartwatch 404, the wearer 400 may move his or her arm in a motion to position the smartwatch 404 within the wearer's field of view. The arm motion 406 may be detected based on movement sensors measuring the movement of the smartwatch 404. The arm movement, and corresponding movement of the smartwatch 404, may be a first gesture (e.g., first event) to wake the smartwatch from a low power state. The various sensors within the smartwatch 404 may measure the arm movement 406. For example, a gyroscope and/or and acceleration sensor may measure the movement of the smartwatch 404 as the wearer 402 of the smartwatch 404 performs the arm movement 406.

As the sensor measures the movement of the smartwatch 404 as the wearer 402 of the smartwatch 404 performs the arm movement 406, a processor in the smartwatch compares data from the sensors with a gesture trigger point. If the sensor data indicates that the gesture trigger point was exceeded, the smartwatch 404 may interpret the first gesture as being indicative of a command request. However, if the sensor data indicates that the gesture trigger point was not exceeded, the smartwatch 404 may interpret the movement of the smartwatch 404 as the wearer 402 of the smartwatch 404 performs the arm movement 406 as being a movement that is not indicative of a command request. The smartwatch 404 may also be configured to adapt the gesture trigger point. The gesture trigger point may be adapted based on either an input from the wearer 402, from a learning algorithm, or by other means. The adaption process will be discussed further below.

After the smartwatch 404 interprets the movement of the smartwatch 404 in response to the first gesture as being indicative of a command request, the smartwatch 404 may begin to monitor for a second event. As shown in FIG. 4B, the second event may be a wearer 402 of the smartwatch 404 providing an audio signal 456 to the smartwatch 404. The audio signal 456 may take many different forms depending on a specific embodiment. In one embodiment, the audio signal 456 may be a verbal command to wake the smartwatch 404. An example verbal command may be the wearer 402 saying, “wake up.” In other embodiments, the verbal command may be an instruction for the smartwatch 404 to perform a function. For example, the wearer 402 may say, “camera,” “take a picture,” “send email,” or a verbal command for other smartwatch 404 functions. Therefore, in some embodiments, the second event may be a sound that provides an instruction to the smartwatch 404.

In still further embodiments, the audio signal 456 may include a verification of the wearer 402 of the smartwatch 404. For example, the wearer may initially set up the smartwatch 404 and include a wake command. The wearer 402 may specify his or her own sound that will be audio signal 456. By choosing his or her own sound, the wearer 402 of the smartwatch 404 may increase the security of accessing the smartwatch 404. Therefore, in some embodiments, the second event may be a wearer-specific sound.

In additional embodiments, the second event may be something other than receiving an audio signal. For example, the second event may be a detection of light, a touch-based input, a movement of the smartwatch 404, or other input.

FIG. 5 shows an example method 500 for interacting with the smartwatch. The method 500 may be used to intelligently wake a smartwatch from a sleep mode (e.g., switch the smartwatch from a first mode to a second mode). The power used by the smartwatch may be reduced by the use of a sleep mode. While in the sleep mode, the watch may not supply power to a majority of the sensors and/or the screen. In order to exit sleep mode, the watch may use method 500 to efficiently wake the smartwatch from a sleep mode. In some embodiments, the method 500 begins at block 501 where smartwatch detects a first event with a first sensor located in the smartwatch based on the first event indicating a command request.

In some embodiments, a method similar to method 500 may be used to as part of training mode for a smartwatch. Further, a method similar to method 500 may be used during the operation of a smartwatch, but not while the smartwatch is in a sleep mode. For example, during normal operation of the smartwatch, the watch may operate with some sensors powered down. Shutting off some sensors may reduce the power used by the smartwatch. Method 500 may function in a similar way whether the smartwatch is in a training mode, in a sleep mode, or operating with some sensors powered down. Generally, method 500 may function to switch the smartwatch from a first mode to a second mode. Across the various embodiments, the method 500 begins at block 501 where smartwatch detects a first event with a first sensor located in the smartwatch based on the first event indicating a command request.

In other embodiments, the method 500 is only performed after a pre-condition event occurs. For example, pre-condition event may be a light sensor sensing ambient light. In this example, method 500 may only be performed once the light sensor senses an ambient light. The pre-condition requirement would prevent the watch from accidently being activated while it is still covered by a wearer's clothing. In other embodiments, the pre-condition even may be something other than a light sensor sensing ambient light.

At block 501, the smartwatch detects a first event with a first sensor located in a device. In some embodiments, the first sensor is a motion sensor. The wearer of the smartwatch may wear the smartwatch on his or her arm. When he or she wishes to view or interact with the smartwatch, the wearer may move his or her arm in a motion to view the watch. At block 501, the movement of the smartwatch as the wearer performs the first movement to view the smartwatch is detected. The arm motion, as detected by the smartwatch, may be a first gesture (e.g., first event) to wake the smartwatch from a low power state. At least one sensor within the smartwatch may measure the movement of the smartwatch associated with the corresponding arm movement via monitoring movement sensors within the smartwatch. For example, a gyroscope and/or and acceleration sensor in the smartwatch may measure the arm movement. In various embodiments, other sensors may be used at block 501. Further, the sensors may be configured to detect events other than a motion.

As the sensor measures the movement of the smartwatch associated with the corresponding movement of the wearer's arm, the smartwatch compares data from the sensors with a gesture trigger point. When the sensor data indicates that a gesture trigger point was exceeded, the smartwatch may interpret the first gesture as being indicative of a command request. For example, the smartwatch may be configured to detect a movement of bringing the watch into the field of view (e.g., a large movement) indicative of a command request.

However, if the sensor data indicates that a gesture trigger point was not exceeded, the smartwatch may interpret the arm movement as being a movement that is not indicative of a command request. For example, as the wearer of the smartwatch moves, the smartwatch will naturally move as the wearer moves. The gesture trigger point may be configured so normal day-to-day movements will not exceed the gesture trigger point. The smartwatch may also be configured to adapt the gesture trigger point. When the smartwatch movement exceeds the gesture trigger point, it is said to indicate a command request.

The gesture trigger point may be adapted based on either an input from the wearer, from a learning algorithm, or by other means. In one embodiment, the smartwatch is configured with a setup mode. When the setup mode is run, the smartwatch may perform a gesture trigger point setup routine. The setup routine may request a smartwatch wearer perform a variety of movements so the smartwatch can create the gesture trigger point. For example, the smartwatch may request the wearer move his or her arm from the relaxed state into the position from which he or she will operate the smart watch. After performing this action one (or more) time, the smartwatch may create a gesture trigger point. Additionally, the smartwatch may request the wearer walk around for a period of time. By having the wearer walk around without accessing the smartwatch, it may aid in creating the gesture trigger point as movements related to walking can be determined to be not exceeding the gesture trigger point.

In further embodiments, the smart watch may be able to adapt the gesture trigger point during operation of the smartwatch. The gesture trigger point may be adapted in a variety of ways. For example, because the smartwatch monitors movements and compares them to the gesture trigger point, the smartwatch will be able to tell if a current gesture trigger point is being exceeded by a large amount with each activation of the smartwatch. If this is the case, the smartwatch may adapt the gesture trigger point to require a larger movement, so the gesture trigger point is exceeded by a smaller value. If the gesture trigger point is adapted, the smartwatch is less likely to prematurely activate.

In some embodiments, the threshold may include specific movement parameters based on the specific type of sensor used in the smart watch. In one example, the threshold may include an X-, Y-, and Z-axis acceleration and/or velocity. When adapting the threshold, the values of the X-, Y-, and Z-axis acceleration and/or velocity that make up the threshold may be adjusted. For example, if a wearer of the smartwatch changes the position in which he or she wears the smartwatch, the appropriate threshold values may change. Thus, by adapting the values, the smartwatch may perform more reliably for a wearer.

In another embodiment, the smartwatch may receive an input from a wearer that he or she attempted to wake the smartwatch but there was an error. For example, the gesture trigger point may not have been exceeded by the gesture. Hence, the watch would not have activated. However, if the wearer wished to power on the smartwatch with the respective gesture, providing an input indicating the error will allow the watch to adapt the gesture trigger point to accommodate the gesture. For example, the smartwatch may adjust the trigger point so that the previously performed gesture would exceed the trigger point.

At block 502, based on the first event indicating a command request, the smartwatch powers on a second sensor located in the device. In order to preserve battery charge of the smartwatch, the smartwatch keeps unneeded sensors unpowered. Once the first event indicates a command request, the smartwatch may power on an additional sensor. The additional sensor may be configured to detect a second event associated with the command request. However, in order to save the battery charge of the smartwatch, the second sensor is not powered until the first sensor indicates a command request. In some embodiments, the second sensor may be a microphone and associated digital signal processing (DSP) hardware. The second sensor may be configured to receive and interpret an audio signal.

At block 503, the smartwatch detects a second event with the second sensor. After the smartwatch interprets the first gesture as being indicative of a command request and the second sensor is responsively powered on, the smartwatch may begin to monitor for a second event with the second sensor. As previously discussed with respect to FIG. 4, the second event may be a wearer of the smartwatch providing an audio signal to the smartwatch. The audio signal may take many different forms depending on a specific embodiment, ranging from a wake instruction, to a smartwatch command, and even possibly a biometric authentication.

In one embodiment, the audio signal may be a verbal instruction to wake the smartwatch. An example verbal instruction may be the wearer saying, “wake up.” In other embodiments, the second sensor may receive a verbal command, which may be an instruction for the smartwatch to perform a function. For example, the wearer may say, “camera,” “take a picture,” “send email,” or a verbal command for other smartwatch functions. Therefore, in some embodiments, the second event may be a sound that provides an instruction to the smartwatch. A digital signal processor may analyze the received audio signal to determine if it includes a wake instruction for the smartwatch. If no wake instruction is received within a predetermined amount of time, method 500 may return to block 501.

In still further embodiments, the audio signal may include a verification of the wearer of the smartwatch. For example, when the wearer performs the initial set up of the smartwatch, he or she may program a wake command. The wake command specified by the wearer may be his or her own sound that will be used to wake the device. The sound may either be a sound or noise that only the wearer knows or it may be a simple command. By choosing his or her own sound, the wearer of the smartwatch may increase the security of accessing the smartwatch. Alternatively, the smartwatch may also use biometric information with the second sensor. For example, the smartwatch may also attempt to determine whether the voice providing the wake command is the same voice that programmed the wake command. In this example the smartwatch may not only analyze what is said, but the audio parameters associated with how it was said. This embodiment may prevent unauthorized users from accessing the smartwatch even if the unauthorized user knows the correct wake command.

At block 504, based on the second sensor indicating a command request, the smartwatch switches to a second mode. In some embodiments, switching modes may be waking the device, performing a command, switching to an operation mode based on an authentication, etc. In some embodiments, when the second sensor indicates a command request, the smartwatch fully powers itself on. All sensors and the display may be powered up when the smartwatch is fully powered. The watch may be fully operational at block 504.

In other embodiments, the smartwatch may power on features at block 504 based on the verbal command (or other input) at block 503. For example, if the verbal command is to take a picture, the smartwatch may only power on components that are required to take a picture. By only enabling a subset of smartwatch components, the smartwatch may be able to preserve battery power while still providing the functionality instructed by the wearer. The components of the smartwatch that are powered on in response to the input at block 503 depend on the respective input. Thus, the smartwatch may contain some program logic that determines which components to power on in response to the input.

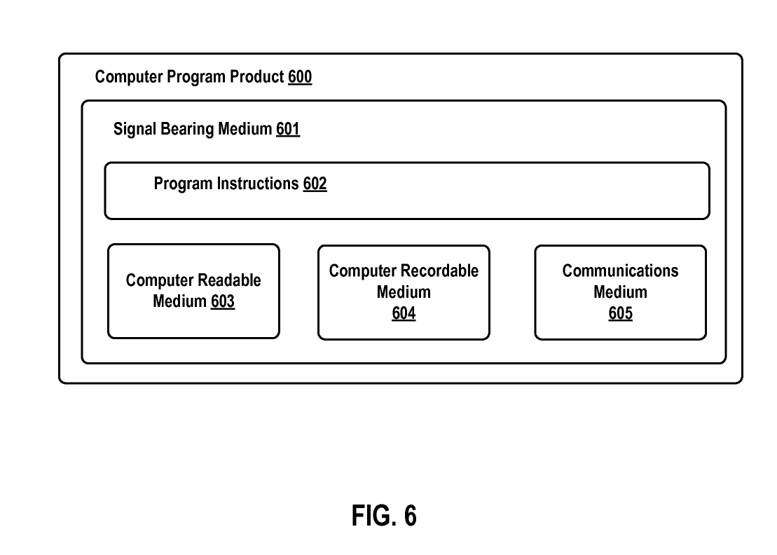

The disclosed methods can be implemented as computer program instructions encoded on a non-transitory computer-readable storage medium in a machine-readable format, or on other non-transitory media or articles of manufacture. FIG. 6 illustrates a computer program product 600, according to an embodiment. The computer program product 600 includes a computer program for executing a computer process on a computing device, arranged according to some disclosed implementations.

The computer program product 600 is provided using a signal bearing medium 601. The signal bearing medium 601 can include one or more programming instructions 602 that, when executed by one or more processors, can provide functionality or portions of the functionality discussed above in connection with FIGS. 1-6. In some implementations, the signal bearing medium 601 can encompass a computer-readable medium 603 such as, but not limited to, a hard disk drive, a CD, a DVD, a digital tape, or memory. In some implementations, the signal bearing medium 601 can encompass a computer-recordable medium 604 such as, but not limited to, memory, read/write (R/W) CDs, or R/W DVDs. In some implementations, the signal bearing medium 601 can encompass a communications medium 605 such as, but not limited to, a digital or analog communication medium (for example, a fiber optic cable, a waveguide, a wired communications link, or a wireless communication link). Thus, for example, the signal bearing medium 601 can be conveyed by a wireless form of the communications medium 605 (for example, a wireless communications medium conforming with the IEEE 802.11 standard or other transmission protocol).

The one or more programming instructions 602 can be, for example, computer executable instructions. A computing device (such as the processor 126 of FIG. 1) can be configured to provide various operations in response to the programming instructions 602 conveyed to the computing device by one or more of the computer-readable medium 603, the computer recordable medium 604, and the communications medium 605.

While various examples have been disclosed, other examples will be apparent to those skilled in the art. The disclosed examples are for purposes of illustration and are not intended to be limiting, with the true scope and spirit being indicated by the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
operating a wrist-wearable computing device in a first operating mode in which one or more first sensors are powered by the battery and the one or more second sensors are not powered by the battery;
detecting data from the one or more first sensors corresponding to a movement of the wrist wearable computing device that exceeds at least one movement threshold;
in response to detecting data from the one or more first sensors corresponding to the movement of the wrist wearable computing device that exceeds the at least one movement threshold, powering on the one or more second sensors; and
after powering on the one or more second sensors, detecting audio data from the one or more second sensors that comprises a predetermined voice command;
in response to detecting the audio data that comprises the predetermined voice commend, switching from the first operating mode to a second operating mode, wherein the second mode comprises powering on at least one additional component of the wrist-wearable computing device based on the voice command.

2. The method of claim 1, wherein the audio data provides an authentication.

3. The method of claim 1, further comprising:
the predetermined voice command indicating a subsequent action, and
wherein one or more second sensors are powered on comprises powering on components of the device related to the subsequent action.

4. The method of claim 3, wherein the subsequent action is operating a camera and powering on components of the device comprises powering on a camera.

5. The method of claim 1, further comprising a third sensor, wherein the third sensor is powered while in the first mode and configured to configured to detect a pre-condition event and provide an enabling indicator and wherein powering on the one or more second sensors is performed in response to both: (a) detecting data from the one or more first sensors, and (b) detecting the enabling indicator from the third sensor.

6. The method of claim 5, wherein the third sensor is a light sensor.

7. A method comprising:
operating a wrist-wearable computing device in a first operating mode in which one or more first sensors are powered by the battery and the one or more second sensors are not powered by the battery;
while in the first operating mode, receiving an input-error signal that indicates the wrist wearable computing device failed to detect a movement of the wrist wearable computing device that was intended to exceed the at least one movement threshold;
in response to the input-error signal, powering the one or more second sensors;
after powering on the one or more second sensors, detecting audio data from the one or more second sensors that comprises a predetermined voice command;
in response to detecting the audio data that comprises the predetermined voice commend, switching from the first operating mode to a second operating mode, wherein the second mode comprises powering on at least one additional component of the wrist-wearable computing device based on the voice command.

8. The method of claim 7, further comprising a third sensor, wherein the third sensor is powered while in the first mode and configured to configured to detect a pre-condition event and provide an enabling indicator and wherein powering on the one or more second sensors is performed in response to both: (a) detecting input-error signal, and (b) detecting the enabling indicator from the third sensor.

9. The method of claim 8, wherein the third sensor is a light sensor.

10. The method of claim 7, wherein the at least one movement threshold is decreased based on a movement of the computing device associated with the input-error signal.

11. A wrist wearable device comprising:
one or more first sensors configured to detect a first event;
a second sensor configured to detect a second event;
a processing unit; and
a battery configured to provide power to the first sensor, the second sensor, and the processing unit,
wherein the processing unit is configured to:
operate the wrist-wearable computing device in a first operating mode in which the one or more first sensors are powered by the battery and the one or more second sensors are not powered by the battery;
detect data from the one or more first sensors corresponding movement of the wrist wearable computing device that exceeds at least one movement threshold;
in response to detecting data from the one or more first sensors corresponding to the movement of the wrist wearable computing device that exceeds the at least one movement threshold, power on the one or more second sensors; and
after powering on the one or more second sensors, detecting audio data from the one or more second sensors that comprises a predetermined voice command;
in response to detecting the audio data that comprises the predetermined voice commend, switching from the first operating mode to a second operating mode, wherein the second mode comprises powering on at least one additional component of the wrist-wearable computing device based on the voice command.

12. The device of claim 11, wherein the audio data provides an authentication.

13. The device of claim 11, further comprising:
the predetermined voice command indicating a subsequent action, and
wherein one or more second sensors are powered on comprises powering on components of the device related to the subsequent action.

14. The device of claim 13, wherein the subsequent action is operating a camera and powering on components of the device comprises powering on a camera.

15. The device of claim 11, further comprising a third sensor, wherein the third sensor is powered while in the first mode and configured to configured to detect a pre-condition event and provide an enabling indicator and wherein powering on the one or more second sensors is performed in response to both: (a) detecting data from the one or more first sensors, and (b) detecting the enabling indicator from the third sensor.

16. The device of claim 13, wherein the third sensor is a light sensor.

17. A wrist wearable device comprising:
a first sensor configured to detecting a first event;
a second sensor configured to detect a second event;
a processing unit; and
a battery configured to provide power to the first sensor, the second sensor, and the processing unit,
wherein the processing unit is configured to:
operate the wrist-wearable computing device in a first operating mode in which the one or more first sensors are powered by the battery and the one or more second sensors are not powered by the battery;
while in the first operating mode, receive an input-error signal that indicates the wrist wearable device failed to detect a movement of the wrist wearable ting device that was intended to exceed the at least one movement threshold;
in response to the input-error signal, power the one or more second sensors;
after powering on the one or more second sensors, detecting audio data from the one or more second sensors that comprises a predetermined voice command;
in response to detecting the audio data that comprises the predetermined voice commend, switching from the first operating mode to a second operating mode, wherein the second mode comprises powering on at least one additional component of the wrist-wearable computing device based on the voice command.

18. The device of claim 17, further comprising a third sensor, wherein the third sensor is powered while in the first mode and configured to configured to detect a pre-condition event and provide an enabling indicator and wherein powering on the one or more second sensors is performed in response to both: (a) detecting input-error signal, and (b) detecting the enabling indicator from the third sensor.

19. The device of claim 18, wherein the third sensor is a light sensor.

20. The device of claim 17, wherein the at least one movement threshold is decreased based on a movement of the computing device associated with the input-error signal.

21. The method of claim 1, further comprising:
determining that the movement of the computing device exceeds the at least one movement threshold by more than a threshold amount; and
setting the at least one movement threshold to a higher value while in the second mode.

22. The method of claim 7, further comprising, in response to the input-error signal, setting the at least one movement threshold to a lower value while in the second mode.

23. The method of claim 11, wherein the processor is further configured to:
determine that the movement of the computing device exceeds the at least one movement threshold by more than a threshold amount; and
set the at least one movement threshold to a higher value while in the second mode.

23. The method of claim 17, further comprising, in response to the input-error signal, setting the at least one movement threshold to a lower value while in the second mode.
